(19) United States
(12) Patent Application Publication
(10) Pub. No.: US 2018/0182138 A1
(43) Pub. Date: Jun. 28, 2018

(54) FIGURE PLOTTING DEVICE, FIGURE PLOTTING METHOD, AND RECORDING MEDIUM

(71) Applicant: CASIO COMPUTER CO., LTD., Tokyo (JP)

(72) Inventors: Kentaro OKUMA, Tokyo (JP); Hirokazu TANAKA, Tokyo (JP)

(73) Assignee: CASIO COMPUTER CO., LTD., Tokyo (JP)

(21) Appl. No.: 15/849,892

(22) Filed: Dec. 21, 2017

(30) Foreign Application Priority Data
Dec. 26, 2016 (JP) 2016-250412

(51) Int. Cl. G06T 11/20; G06T 17/10

(52) U.S. Cl. CPC G06T 11/206; G06T 17/10

(57) ABSTRACT

A figure plotting device has a controller. The controller performs following processes: plotting a first shape which is formed by connecting a plurality of points included in a plane which is a desired plotting object, thereby plotting the plane in a plotting area of a display screen of a display unit; and upon plotting the plane, in a case where at least one of the plurality of points of the first shape is outside the plotting area and one or more points of the plurality of points of the first shape is inside the plotting area, plotting a second shape different from the first shape by connecting at least one point and the one or more points, the at least one point being obtained by shifting at least one of the plurality of points of the first shape outside the plotting area to corresponding at least one point positioned inside the plotting area, the one or more points.

### CROSS-REFERENCE TO RELATED APPLICATION

This application claims priority from Japanese Patent Application No. 2016-250412, filed on Dec. 26, 2016, the entire subject matter of which is incorporated herein by reference.

### BACKGROUND

### 1. Technical Field

The technical field relates to a figure plotting device, a figure plotting method, and a non-transitory recording medium having a control program recorded thereon.

### 2. Description of Related Art

In the related art, as a method of plotting three-dimensional (3D) figures, there is a method of determining Z coordinates corresponding to coordinates (X, Y) of individual points in an XYZ-coordinate space by a function Z×f(x, y) and plotting the determined coordinates (X, Y, Z) as a 3D graph (see Japanese Patent Application Publication No. 2005-182125 for instance). This method of plotting 3D figures as 3D graphs needs only relatively easy arithmetic processing, and thus can be implemented without requiring a high-speed high-performance processor (CPU), however, it cannot easily plot circular cylinders (including elliptic cylinders), cones (including elliptic cones), spheres (elliptic spheres), and so on.

Also, in the related art, for example, as disclosed in Japanese Patent Application Publication No. 2005-182125, there is a method of modeling the surfaces of 3D figures 3D as sets of polygons (grids). This method can plot every 3D figure and can also perform processing such as shifting, scaling, reversing, and mutating; however, relatively heavy arithmetic processing is required, and a process of plotting a polygon protruding outward from a plotting area determined separately is not particularly disclosed.

### BRIEF SUMMARY

A figure plotting device having a controller, wherein

the controller performs following processes:
plotting a first shape which is formed by connecting a plurality of points included in a plane which is a desired plotting object, thereby plotting the plane in a plotting area of a display screen of a display unit; and

upon plotting the plane, in a case where at least one of the plurality of points of the first shape is outside the plotting area and one or more points of the plurality of points of the first shape is inside the plotting area, plotting a second shape different from the first shape by connecting at least one point and the one or more points, the at least one point being obtained by shifting at least one of the plurality of points of the first shape outside the plotting area to corresponding at least one point positioned inside the plotting area, the one or more points.

A control method of a figure plotting device having a controller comprising following processes:
plotting a first shape which is formed by connecting a plurality of points included in a plane which is a desired plotting object, thereby plotting the plane in a plotting area of a display screen of a display unit; and

upon plotting the plane, in a case where at least one of the plurality of points of the first shape is outside the plotting area and one or more points of the plurality of points of the first shape is inside the plotting area, plotting a second shape different from the first shape by connecting at least one point and the one or more points, the at least one point being obtained by shifting at least one of the plurality of points of the first shape outside the plotting area to corresponding at least one point positioned inside the plotting area, the one or more points.

A non-transitory recording medium having a program recorded thereon that is executable to control a computer to perform following processes:
plotting a first shape which is formed by connecting a plurality of points included in a plane which is a desired plotting object, thereby plotting the plane in a plotting area of a display screen of a display unit; and

upon plotting the plane, in a case where at least one of the plurality of points of the first shape is outside the plotting area and one or more points of the plurality of points of the first shape is inside the plotting area, plotting a second shape different from the first shape by connecting at least one point and the one or more points, the at least one point being obtained by shifting at least one of the plurality of points of the first shape outside the plotting area to corresponding at least one point positioned inside the plotting area, the one or more points.

### BRIEF DESCRIPTION OF THE DRAWINGS

The components in the drawings are not necessarily to scale relative to each other.

FIGS. 1A and 1B are front views illustrating the configuration of the external appearance of a figure plotting device 10 according to an embodiment, FIG 1A is view in the case of implementing a graphing calculator 10F as the figure plotting device 10, and FIG. 1B is view in the case of implementing a tablet terminal 10T as the figure plotting device 10, respectively.

FIG. 2 is a block diagram illustrating the electronic circuit configuration of the figure plotting device 10 (10F or 10T).

FIG. 3 is a flow chart illustrating a circular-cylinder (a figure having circles) plotting process which is performed according to a figure display control program 22a of the figure plotting device 10.

FIG. 4 is a flow chart illustrating a circle plotting process included in the circular-cylinder (a figure having circles) plotting process of the figure plotting device 10.

FIGS. 5A to 5D are views illustrating the relation between individual grids constituting a circle and a plotting area Ad when the grids are plotted in the circle plotting process of the figure plotting device 10.

FIGS. 6A to 6D are views illustrating display operations (a first embodiment) corresponding to user's operations according to the circular-cylinder (a figure having circles) plotting process of the figure plotting device 10.

FIGS. 7A to 7C are views illustrating display operations (a second embodiment) corresponding to user's operations according to the circular-cylinder (a figure having circles) plotting process of the figure plotting device 10.

FIGS. 8A to 8C are views illustrating display operations (a third embodiment) corresponding to user's operations according to the circular-cylinder (a figure having circles) plotting process of the figure plotting device 10.

### DETAILED DESCRIPTION

Hereinafter, embodiments of the present invention will be described with reference to the drawings.

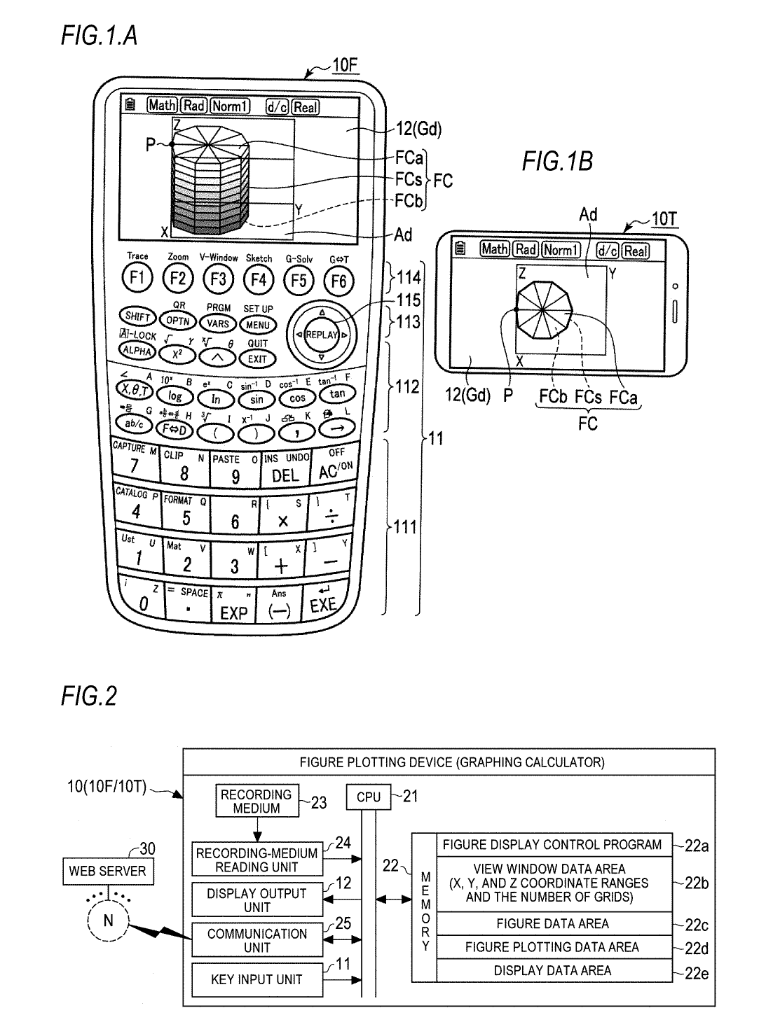

FIGS. 1A and 1B are front views illustrating the configuration of the external appearance of a figure plotting device 10 according to an embodiment, FIG. 1A is view in the case of implementing a graphing calculator 10F as the figure plotting device 10, and FIG. 1B is view in the case of implementing a tablet terminal 10T as the figure plotting device 10, respectively.

As the figure plotting device 10, besides the graphing calculator 10F and the tablet terminal 10T, other devices having a figure plotting function (having a figure display control program) such as a personal computer, a smart phone, a portable phone, a touch panel type personal digital assistant (PDA), an e-book, and a portable game console can be configured.

Also, examples of the figure plotting device 10 like the tablet terminal 10T having no physical keys (buttons) unlike the graphing calculator 10F display a software keyboard similar to keys of the graphing calculator 10F, and performs processing according to key operations on the software keyboard.

The graphing calculator 10F is configured in such a small size that a user can hold it with one hand and operate it with one hand, due to the necessity of portability, and a key input unit 11 and a display output unit (a display unit) 12 are provided on the front surface of the main body of the graphing calculator 10F.

The key input unit 11 includes a number/operation-symbol key group 111 for inputting numerical values or mathematical expressions, or issuing a calculation performance instruction, an arithmetic-function function key group 112 for inputting various arithmetic functions or starting a memory function, a mode setting key group 113 for displaying a menu screen of various operating modes or issuing an operating-mode setting instruction, a function key group 114 for starting various functions displayed along the lower end of the display output unit 12 by one key operation, and a cursor key 115 for perforating various operations such as an operation to move a cursor displayed on the display output unit 12 and an operation to select a data item.

As the number/operation-symbol key group 111, “0” to “9” keys (number keys), “+”, “−”, “×”, and “÷” keys (keys for addition, subtraction, multiplication, and division), an “EXE” (execution) key, an “AC” (clear) key, and so on are arranged.

As the arithmetic-function function key group 112, an “x²” key (a square key), a “sin” (sine) key, a “cos” (cosine) key, a “tan” (tangent) key, and so on are arranged.

As the mode setting key group 113, a “MENU” (menu) key, and a “SHIFT” (shift) key, an “OPTN” (option) key, and so on are arranged.

As the function key group 114, “F1” to “F6” keys are arranged.

Also, each key of the number,operation-symbol key group 111, the arithmetic-function function key group 112, and the mode setting key group 113 is configured so as to be able to act as a key for a function written above the corresponding key, not a function written on the corresponding key, if the corresponding key is operated after the “SHIFT” key is operated. For example, an operation on the “AC” key after an operation on the “SHIFT” key (hereinafter, referred to as a “SHIFT”+“AC” key) acts as an “OFF” (power-off) key. A “SHIFT”+“MENU” key acts as a “SET UP” (set up) key, and a “SHIFT”+“F3” key acts as a “V-Window” (view window) key (for instructing display of a plotting-area setting screen Gv).

The display output unit 12 is composed of a dot matrix type liquid crystal display unit. Also, the display output unit 12 of the tablet terminal 10T is composed of a liquid crystal display unit superimposed on a touch panel.

FIG. 2 is a block diagram illustrating the electronic circuit configuration of the figure plotting device 10 (10F or 10T).

The electronic circuit of the figure plotting device 10 includes not only the key input unit 11 and the display output unit 12 but also a CPU 21 which is a computer, a memory 22, a recording-medium reading unit 24, and a communication unit 25.

The CPU 21 controls operations of the individual units of the circuit according to the figure display control program 22a stored in the memory 22, thereby performing various calculation processes based on key input signals from the key input unit 11. The figure display control program 22a may be stored in the memory 22 in advance, or may be a program read from an external recording medium 23 such as a memory card through the recording-medium reading unit 13 and stored in the memory 22. Even if the user operates the key input unit 11, the figure display control program 22a is not rewritten.

The memory 22 has an area for storing data which the user can rewrite such as data on mathematical expressions, table data, and graph data, other than such information which the user cannot rewrite. If the user sequentially inputs key code data by operating the keys of the key input unit 11, whereby data is created by the key code data, the created data is stored in that area.

Also, the area of the memory 22 for storing data which the user can rewrite includes a V-Window data area 22b, a figure data area 22c, a figure plotting data area 22d, and a display data area 22e.

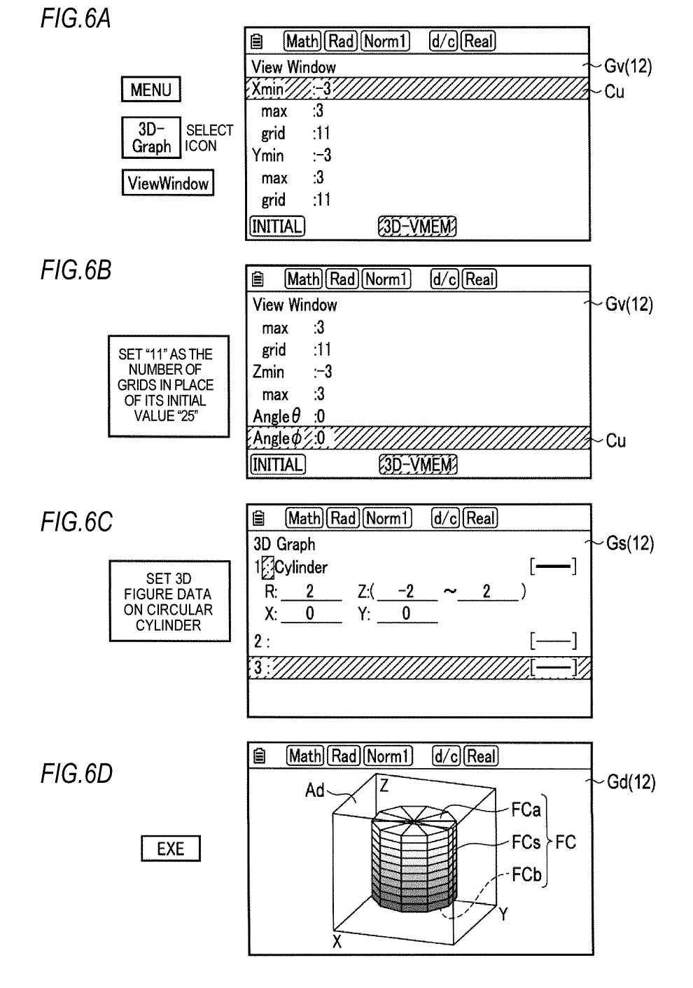

If the user operates the “V-Window” (view window) key, a plotting-area setting screen Gv (see FIGS. 6A and 6B) (here, a plotting-area setting screen Gv for plotting 3D figures) is displayed on the display output unit 12. Then, if the user inputs data on a 3D coordinate plotting area Ad (Xmin, Xmax, Ymin, Ymax, Zmin, and Zmax) for plotting 3D figures and a division number for grids (polygons) by performing operations on the plotting-area setting screen, the input data is stored in the V-Window data area 22b.

If the user operates the “MENU” (menu) key, an operation menu (not shown in the drawings) is displayed, and if the user selects an icon “3D-Graph” for plotting a 3D figure from the operation menu, a 3D graph setting screen Gs (see FIG. 6C) (here, a 3D graph setting screen Gs for plotting a circular cylinder (a figure having circles)) is displayed on the display output unit 12. Then, if the user inputs data on a 3D figure (a figure having circles) (plotting data (the radius R, the height Z, and the coordinates X and Y of the center) for modeling the figure with reference to the plotting area Ad) by operating the 3D graph setting screen, the input data is stored in the figure data area 22c.

If arithmetic processing is performed with reference to the plotting area Ad on the basis of the data on the 3D figure stored in the figure data area 22c, plotting data on the 3D figure (the coordinates of the apexes of individual grids (polygonal grids) constituting grid sets to constitute the surfaces of the 3D figure) is generated, and the generated data is stored in the figure plotting data area 22d.

The display data area 22e includes a memory area corresponding to the display size of the liquid crystal display unit constituting the display output unit 12, and in this memory area, display data to be displayed on the liquid crystal display unit is stored as bitmap data (here, bitmap data developed according to the data on the plotting area and the data on the 3D figure).

The CPU 21 controls operations of the individual circuit units according to commands described in the figure display control program 22a such that software and hardware operate in cooperation with each other, whereby the figure plotting device 10 (10F or 10T) configured as described above implements a figure plotting function to be described in the following operation description.

Now, operations according to the figure plotting function of the figure plotting device 10 according to the above-described configuration will be described.

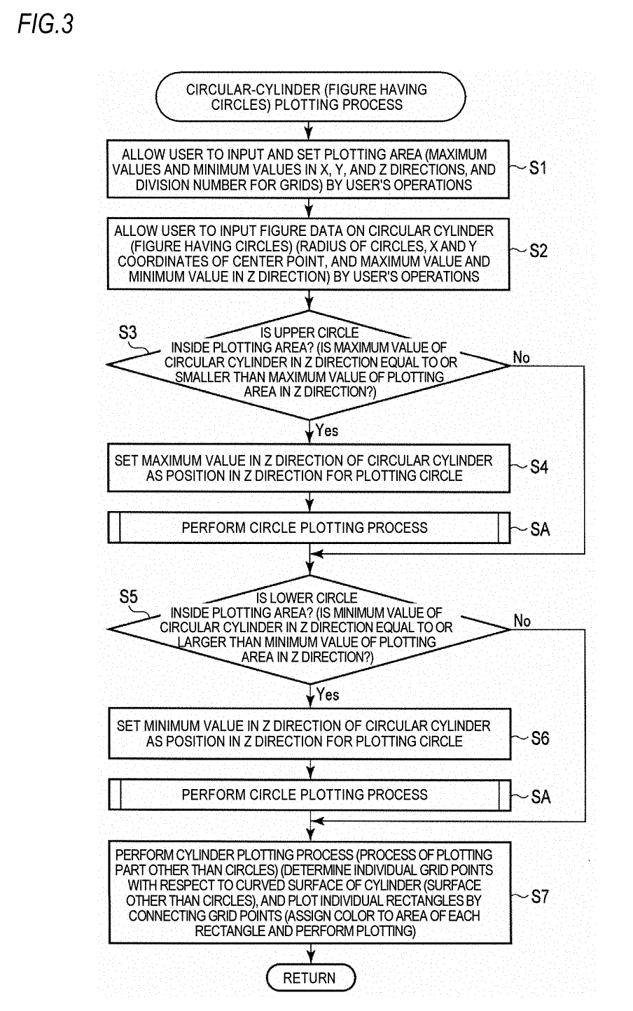

FIG. 3 is a flow chart illustrating a circular-cylinder (a figure having circles) plotting process which is performed according to the figure display control program 22a of the figure plotting device 10.

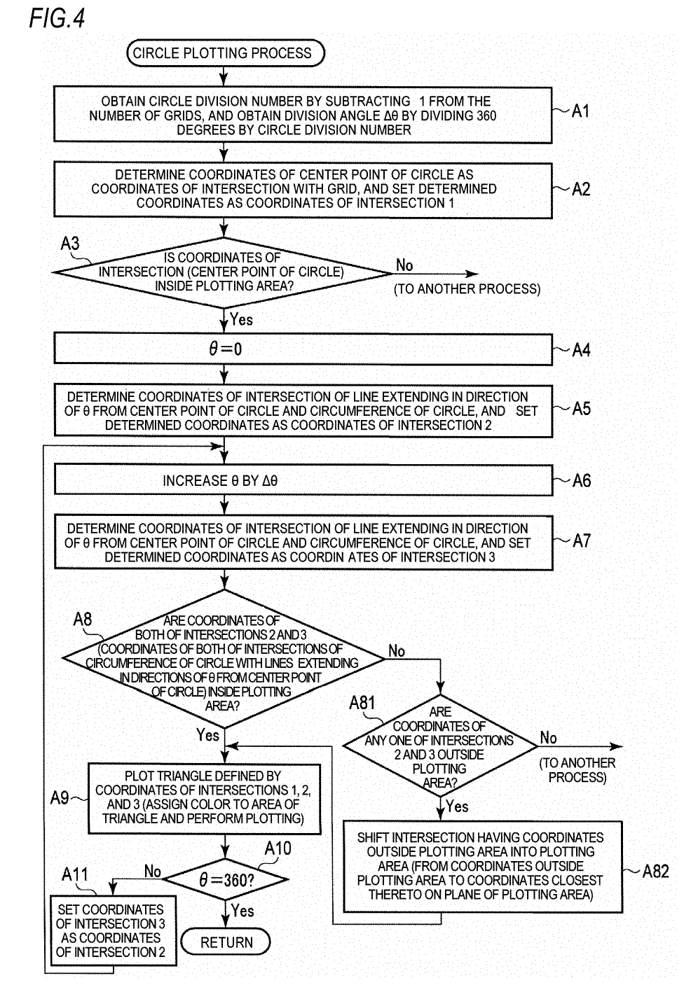

FIG. 4 is a flow chart illustrating a circle plotting process included in the circular-cylinder (a figure having circles) plotting process of the figure plotting device 10.

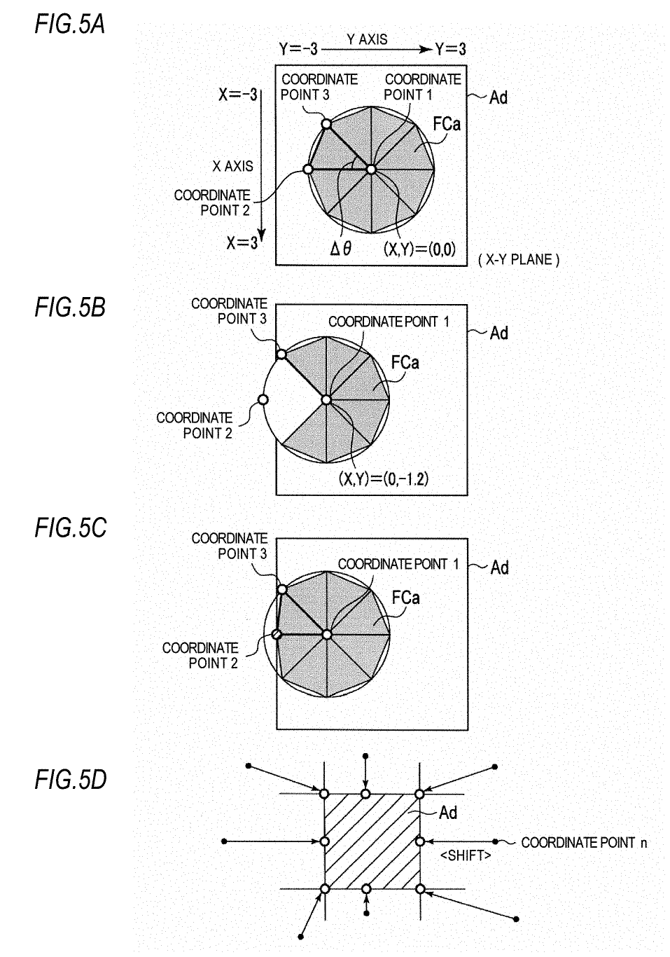

FIGS. 5A to 5D are views illustrating the relation between individual grids constituting a circle and a plotting area Ad when the grids are plotted in the circle plotting process of the figure plotting device 10.

FIGS. 6A to 8C are views illustrating display operations (first to third embodiments) corresponding to user's operations according to the circular-cylinder (a figure having circles) plotting process of the figure plotting device 10.

Now, an overview of the circular-cylinder (a figure having circles) plotting process will be first described.

In the circular-cylinder (a figure having circles) plotting process, if the user sets data on a plotting area and data on a 3D figure (a circular cylinder (a figure having circles)) according to the plotting-area setting screen Gv and the 3D graph setting screen Gs, a 3D-coordinate string constituting the circumference of one circle (an upper lid) and a 3D-coordinate string constituting the circumference of the other circle (a lower lid) are calculated by arithmetic processing (wherein the circles correspond to the data on the circular cylinder). Also, coordinate strings constituting lines connecting the calculated coordinate string corresponding to the one circle and the calculated coordinate string corresponding to the other circle are calculated as coordinate strings constituting the side surface of the circular cylinder by arithmetic processing.

Thereafter, points of coordinates included in the calculated coordinate string corresponding to the one circle, the calculated coordinate string corresponding to the other circle, and the coordinate strings corresponding to the side surface of the circular cylinder and included in the plotting area are plotted in the order of the one circle, the other circle, and the side surface, whereby the set circular cylinder (a figure having circles) is displayed.

At this time, with respect to each of the one circle and the other circle, division is performed along radial lines connecting the coordinate point of the center of the corresponding circle with individual coordinate points corresponding to the circumference of the corresponding circle, and lines connecting the individual coordinate points of the circumference of the corresponding circle, whereby a number of triangles (grids; polygons) are formed, and the set of the formed triangles (grids; polygons) constitutes the surface of the corresponding circle. Also, with respect to the side surface, division is performed along lines connecting the individual coordinate points corresponding to the circumference of the one circle with the individual coordinate points corresponding to the circumference of the other circle, whereby a number of quadrangles (grids) are formed, and the set of the formed quadrangles (grids) constitutes the surface of the side surface.

However; actually, not all of the calculated coordinate points constituting the one circle and the other circle are plotted. As will be described below, a division number for triangles (grids; polygons) to constitute each circle and a division number for quadrangles (grids) to constitute the side surface are set. Then, each of the one circle and the other circle is divided into triangles in the radial direction according to the set division number, and the coordinates of the apexes of the individual triangles are determined, and the corresponding circle is plotted. Also, the side surface is divided into quadrangles in horizontal directions (X-Y directions) and vertical directions (Z directions) along vertical lines connecting coordinate points constituting the individual triangles obtained by dividing the one circle and positioned on the circumference of the one circle with coordinate points constituting the individual triangles obtained by dividing the other circle and positioned on the circumference of the other circle and horizontal lines dividing a part between the one circle and the other circle according to the set division number, and the coordinates of the apexes of the individual quadrangles are determined, and the side surface is plotted.

In the circle plotting process of the present embodiment, for example, as shown in FIG. 5A to 5D, in the case where a triangle constituting a circle FCa has two coordinate points (coordinate points 2 and 3) positioned on the circumference of the corresponding circle, and any one coordinate point (here, the coordinate point 2) of them is positioned outside the set plotting area Ad (between Xmin “−3” and Xmax “3” and between Ymin “−3” and Ymax “3”), the coordinate point (the coordinate point 2) positioned outside the plotting area is changed to a coordinate point closest thereto and positioned in the plotting area Ad, whereby a triangle (coordinate points 1, 2, and 3) is configured, and a pseudo circle is plotted.

Therefore, in the case where the circle FCa protrudes from the plotting area Ad, it is unnecessary to perform cumbersome and heavy surface processing for precisely fitting the protruding part in the plotting area Ad. Therefore, it is possible to plot a good-looking circular cylinder (a figure having circles) without using a high-speed high-performance (expensive) processor (CPU).

### FIRST EMBODIMENT

<Case Where Setting of Circle FCa of Circular Cylinder FC does not Protrude from Plotting Area Ad>

As shown in FIG. 6A, if the user operates the “MENU” key such that the operation menu (not shown in the drawings) is displayed, and selects the icon “3D-Graph” for plotting 3D figures, from the displayed operation menu, and operates the “V-Window” key, the plotting-area setting screen Gv for plotting 3D figures is displayed on the display output unit 12.

Then, if the user inputs Xmin “−3”, Xmax “3”, Ymin “−3”, Ymax “3”, Zmin “−3”, Zmax “3”, and a division number “11” for grids (wherein the default of the division number is “25”) as data on a 3D coordinate plotting area Ad for plotting 3D figures as shown in FIGS. 6A and 6B by operating the plotting-area setting screen. Gv, the input data on the plotting area (Xmin “−3”, Xmax “3”, Ymin “−3”, Ymax “3”, Zmin “−3”, Zmax “3”, and the division number “11” for grids) is stored in the V-Window data area 22b (STEP S1).

Then, as shown in FIG. 6C, a 3D graph setting screen Gs for plotting circular cylinders is displayed on the display output unit 12. If the user inputs data on a circular cylinder (a figure having circles) by operating the 3D graph setting screen Gs, in other words, if the user inputs “2”, “−2”, “2”, “0”, and “0” as the radius R, the minimum value and the maximum value in the height direction (the Z direction), and the X and Y coordinates of the center, respectively, the input data (the radius R “2”, the maximum value “2” and the minimum value “−2” in the height direction (the Z direction), and the X and Y coordinates (0, 0)) on the circular cylinder (a figure having circles) is stored in the figure data area 22c (STEP S2).

Then, if the user operates the “EXE” key as shown in FIG. 6D, whether the upper circle of the circular cylinder (a figure having circles) is inside the plotting area Ad is determined according to whether the maximum value (here, “2”) in the height direction (the Z direction) defined in the data on the circular cylinder (a figure having circles) is equal to or smaller than the maximum value (Zmax “3”) in the Z direction defined inn the data on the plotting area Ad (STEP S3).

In this case, it is determined that the upper circle of the circular cylinder (a figure having circles) is inside the plotting area Ad (“Yes” in STEP S3), and the maximum value in the Z direction (Z=2) defined in the data on the circular cylinder is set as a position in the Z direction for plotting the upper circle (STEP S4).

Then, a transition to the circle plotting process of FIG. 4 is performed, and plotting of the upper circle is performed (STEP SA).

In the circle plotting process, first, a number (=10) for dividing each circle which is a plotting object is obtained by subtracting 1 from the division number for grids (here, “11”) defined in the data on the plotting area, and a division angle Δθ (=36 degrees) is Obtained by dividing 360 degrees by the circle division number (=10) (STEP A1).

Then, the X and Y coordinates (0, 0) of the center defined in the data on the circular cylinder (a figure) are determined as the coordinates of an intersection 1 with a grid (a triangle) to constitute the circle which is a plotting object (STEP A2), and whether the coordinates of the intersection 1 (the X and Y coordinates (0, 0) of the center of the circle) is inside a horizontal plotting area (between Xmin “−3” and Xmax “3” and between Ymin “−3” and Ymax “3”) defined in the data of the plotting area Ad is determined (STEP A3).

Then, it is determined that the coordinates of the intersection 1 (the X and Y coordinates (0, 0) of the center of the circle) is inside the plotting area (between Xmin “−3” and Xmax “3” and between Ymin “−3” and Ymax “3”) (“Yes” in STEP A3), and a variable θ is set to 0 degrees (STEP A4).

Thereafter, the coordinates of an intersection of a line expending in the direction of θ (=0 degrees) from the X and Y coordinates (0, 0) of the center of the circle with the circumference of the circle having the radius R (=2) are determined, and are set as the coordinates of an intersection 2 (STEP A5).

Subsequently, the variable θ is increased to 36 degrees by Δθ (STEP A6), and coordinates of an intersection of a line extending in the direction of θ (=36 degrees) from the X and Y coordinates (0, 0) of the center of the circle with the circumference of the circle are determined, and are set as the coordinates of an intersection 3 (STEP A7).

Then, whether the coordinates of both of the intersections 2 and 3 of the circumference of the circle with the lines extending in the directions of 0 degrees (=0) and 36 degrees (=0) from the X and Y coordinates (0, 0) of the center of the circle are inside the plotting area (between Xmin “−3” and Xmax “3” and between Ymin “−3” and Ymax “3”) is determined (STEP A8).

In this case, it is determined that the coordinates of both of the intersections 2 and 3 are inside the plotting area (between Xmin “−3” and Xmax “3” and between Ymin “−3” and Ymax “3”) (“Yes” in STEP A8), and a color is assigned to the area of a triangle defined by the coordinates of the intersections 1, 2, and 3, and the triangle is plotted in a figure plotting data area 22e (STEP A9).

Then, whether the variable θ (36 degrees) has reached 360 degrees is determined (STEP A10), and if it is determined that the variable θ has not reached 360 degrees (“No” in STEP A10), the coordinates of the intersection 3 is set as the coordinates of a new intersection 2 (STEP A11), and processing from STEP A6 is repeated.

In other words, the variable θ is increased to 72 degrees by Δθ (STEP A6), and the coordinates of an intersection of a line extending in the direction of θ (=72 degrees) from the X and Y coordinates (0, 0) of the center of the circle with the circumference of the circle are determined, and are set as the coordinates of a new intersection 3 (STEP A7).

Then, whether the coordinates of both of the intersections 2 and 3 of the circumference of the circle with the lines extending in the directions of 36 degrees (=0) and 72 degrees (=0) from the X and Y coordinates (0, 0) of the center of the circle are inside the plotting area (between Xmin “−3” and Xmax “3” and between Ymin “−3” and Ymax “3”) are determined (STEP A8), and if it is determined that the coordinates of both of the intersections 2 and 3 are inside the plotting area (“Yes” in STEP A8), and a color is assigned to the area of a triangle defined by the coordinates of the intersections 1, 2, and 3, and the triangle is plotted in the figure plotting data area 22e (STEP A9).

Meanwhile, if it determined that the current variable θ is 72 degrees and has not reached 360 degrees (“No” in STEP A10), the coordinates of the intersection 3 is set as the coordinates of a new intersection 2 (STEP A11), and processing from STEP A6 is repeated again (STEPS A6 to A11).

As a result, as shown in FIG. 6D, in the plotting area Ad (defined by Xmin “−3”, Xmax “3”, Ymin “−3”, Ymax “3”, Zmin “−3”, and Zmax “3”), the upper circle FCa composed of ten triangles arranged in the circumferential direction is displayed on the display output unit 12.

Then, returning to the circular-cylinder (a figure having circles) plotting process of FIG. 3 is performed, and whether the lower circle of the circular cylinder (a figure having circles) is inside the plotting area Ad is determined according to whether the minimum value (here, “−2”) in the height direction (the Z direction) defined in the data on the circular cylinder (a figure having circles) is equal to or larger than the minimum value (Zmin “−3”) in the Z direction defined in the data on the plotting area Ad (STEP S5).

In this case, it is determined that the lower circle of the circular cylinder (a figure having circles) is inside the plotting area Ad (“Yes” in STEP S5), and the minimum value in the Z direction (Z=−2) defined in the data on the circular cylinder is set as a position in the Z direction for plotting the lower circle (STEP S6).

Then, a transition to the circle plotting process of FIG. 4 is performed, and plotting of the lower circle is performed (STEP SA).

In other words, in the circle plotting process, in the same way as the processing of STEPS A1 to A11 of the circle plotting process of plotting the upper circle, a lower circle FCb composed of ten triangles arranged in the circumferential direction is plotted at a Z direction position (Z=−2) in the plotting area Ad (defined by Xmin “−3”, Xmax “3”, Ymin “−3”, Ymax “3”, Zmin “−3”, and Zmax “3”), and is displayed on the display output unit 12.

Then, returning to the circular-cylinder (a figure having circles) plotting process of FIG. 3 is performed, and a side surface FCs of the circular cylinder (a figure having circles) is plotted between the upper circle FCa and the lower circle FCb. In other words, on the basis of the coordinates of the intersections 2 and 3 constituting the individual triangles of the upper circle FCa and corresponding to the circumference of the upper circle, the coordinates of the intersections 2 and 3 constituting the individual triangles of the lower circle FCb and corresponding to the circumference of the lower circle, and the division number for grids (“11”), coordinate points which are apexes of individual grids (rectangles) obtained as grids to constitute the side surface FCs are determined by performing division into ten partitions in vertical directions and division into ten partitions in horizontal directions, and the determined coordinate points are connected in the vertical directions and the horizontal directions, whereby the individual rectangles are configured, and a color is assigned to the areas of them, and the side surface is plotted in the figure plotting data area 22e (STEP S7).

As a result, as shown in FIG. 6D, a circular cylinder (a figure having circles) FC (FCa+FCb+FCs) having the X and Y coordinates (0, 0) of the center, the radius R (=2), and the height (between −2 and 2 in the Z direction) is plotted in the plotting area Ad (defined by Xmin “−3”, Xmax “3”, Ymin “−3”, Ymax “3”, Zmin “−3”, and Zmax “3”), and is displayed as a 3D figure screen (a display screen) Gd on the display output unit 12.

### SECOND EMBODIMENT

<Case Where Setting of Circle FCa of Circular Cylinder FC Protrudes in Horizontal Direction from Plotting Area Ad>

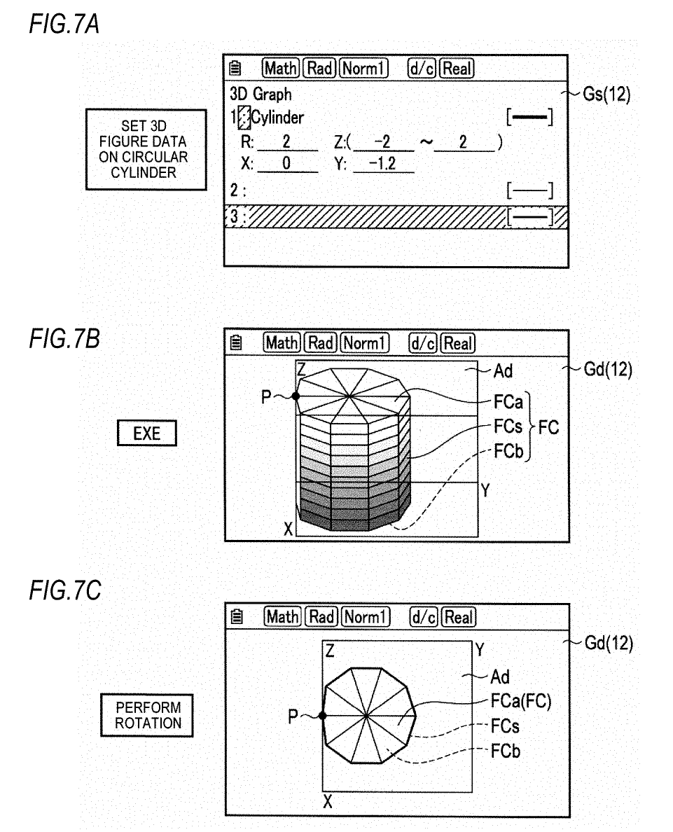

In a second embodiment, the case where the user sets the same plotting area (Xmin “−3”, Xmax “3”, Ymin “−3”, Ymax “3”, Zmin “−3”, Zmax “3”, and the division number for grids “11”) as that set according to the plotting-area setting screen Gv shown in FIGS. 6A and 6B, and inputs data on a circular cylinder (a figure having circles), i.e. the radius R “2”, the minimum value “−2” and the maximum value “2” in the height direction (the Z direction), and the X and Y coordinates (0, −1.2) of the center as shown in FIG. 7A will be described.

In other words, in a circular-cylinder (a figure having circles) plotting process of the second embodiment, the circular cylinder is like a circular cylinder obtained by shifting the center of the circular cylinder (a figure having circles) FC plotted in the first embodiment in the Y direction by −1.2; however, in each of the upper circle plotting process and the lower circle plotting process shown in FIG. 4, for example, in the case where it is assumed that the negative direction of the Y axis is the direction of θ when the variable θ is 0 degrees (or 360 degrees), if it is determined that X and Y coordinates (0, −3.2) of an intersection 2 (or 3) of the circumference of a circle having the radius R (=2) and a line extending in the direction of θ from the X and Y coordinates (0, −1.2) of an intersection 1 which is the center of the circle are outside the plotting area (between Xmin “−3” and Xmax “3” and between Ymin “−3” and Ymax “3”), processing of STEPS A81 and A82 different from processing in the first embodiment is performed.

Specifically, as shown in FIG. 7B, in the circle plotting process of the upper circle FCa of the circular cylinder (a figure having circles) FC, the coordinates of an intersection 2 (or 3) which is an intersection P (having X and Y coordinates (0, −3.2)) of the circumference of the circle having the radius R (=2) with the line extending in the direction of θ (=0 degrees) from the X and Y coordinates (0, −1.2) of the intersection 1 which is the center of the circle are determined (STEPS A4 to A7), and it is determined that the coordinates of the intersection 2 (or 3) are outside the plotting area (between Xmin “−3” and Xmax “3” and between Ymin “−3” and Ymax “3”) (“Yes” in STEP A81).

Then, the X and Y coordinates of the intersection 2 (or 3) which is the intersection P (having X and Y coordinates (0, −3.2)) determined as being outside the plotting area are shifted to X and Y coordinates (here, (0, −3)) closest thereto and positioned in the plotting area (between Xmin “−3” and Xmax “3” and between Ymin “−3” and Ymax “3”) as shown in FIGS. 5B and 5C (STEP A82).

After the coordinates of the intersection 2 (or 3) are shifted to the X and Y coordinates (0, −3) closest thereto and positioned in the plotting area, a color is assigned to the area of a triangle defined by the coordinates of the intersections 1, 2, and 3, and the triangle is plotted (STEP A9).

Subsequently, the other triangles each of which is defined by the coordinates of intersections 1, 2, and 3 wherein the intersection 2 is inside the plotting area Ad are plotted according to the same processing (STEPS A6 to A11) as that of the first embodiment, and as shown in FIG. 7B, the upper circle FCa composed often triangles arranged in the circumferential direction is displayed on the display output unit 12.

Also, the circle plotting process of the lower circle FCb of the circular cylinder (a figure having circles) FC is similar to the circle plotting process of the upper circle FCa, and thus a description thereof will not be made.

Thereafter, similarly in the circular-cylinder (a figure having circles) plotting process of the first embodiment, a side surface FCs of the circular cylinder (a figure having circles) is plotted between the upper circle FCa and the lower circle FCb, and a circular cylinder (a figure having circles) FC (FCa+FCb+FCs) having the X and Y coordinates (0, −1.2) of the center, the radius R (=2), and the height (between −2 and 2 in the Z direction) is plotted in the plotting area Ad (defined by Xmin “−3”, Xmax “3”, Ymin “−3”, Ymax “3”, Zmin “−3”, and Zmax “3”), and is displayed on the display output unit 12 (STEP A7).

Therefore, even in the case where the circles FCa and FCb are set to protrude from the plotting area Ad, it is unnecessary to perform cumbersome and heavy surface processing for precisely fitting the protruding part in the plotting area Ad. Therefore, it is possible to plot a good-looking circular cylinder (a figure having circles) without using a high-speed high-performance (expensive) processor (CPU).

FIG. 7C shows a display state which is obtained by performing a process of rotating the plotted circular cylinder (a figure having circles) FC shown in FIG. 7B in a planar direction.

Also, in the circular cylinder (a figure having circles) plotted as shown in FIG. 7B, rectangles of the side surface FCs positioned between two triangles of the upper circle FCa and two triangles of the lower circle FCb including the intersections P which are coordinate points 2 (or 3) shifted into the plotting area Ad have not been plotted for the purpose of convenience; however, they may be plotted.

### THIRD EMBODIMENT

<Case Where Setting of Circle FCa of Circular Cylinder FC Protrudes in Horizontal Direction from Plotting Area Ad and Maximum Value in Height Direction (Z Direction) of Circular Cylinder FC Exceeds Maximum Value in Z Direction of Plotting Area Ad>

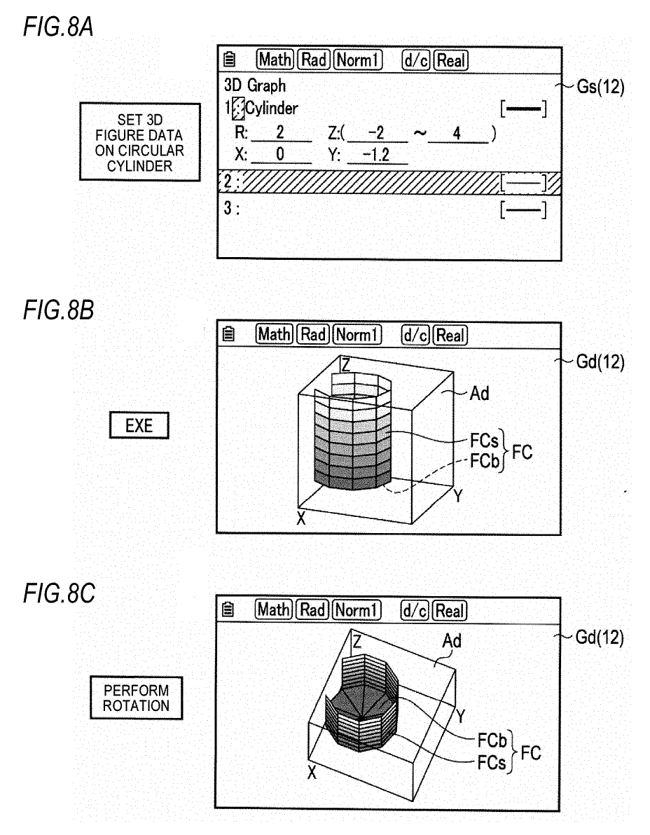

In a third embodiment, the case where the user sets the same plotting area Ad (X “−3”, Xmax “3”, Ymin “−3”, Ymax “3”, Zmin “−3”, Zmax “3”, and the division number for grids “11”) as that set according to the plotting-area setting screen Gv shown in FIGS. 6A and 6B, and inputs data on a circular cylinder (a figure having circles), i.e. the radius R “2”, the minimum value “−2” and the maximum value “4” in the height direction (the Z direction), and the X and Y coordinates (0, −1.2) of the center as shown in FIG. 8A will be described.

In other words, in a circular-cylinder (a figure having circles) plotting process of the third embodiment, the circular cylinder is like a circular cylinder obtained by shifting the center of the circular cylinder (a figure having circles) FC plotted in the first embodiment in the Y direction by −1.2 and increasing the height of the circular cylinder (a figure having circles) FC in the Z direction by “+2” such that a minimum value and a maximum value in the Z direction become −2 and 4, respectively. Therefore, in the circular-cylinder (a figure having circles) plotting process shown in FIG. 3, it is determined that the upper circle FCa of the circular cylinder (a figure having circles) is outside the plotting area Ad (“No” in STEP S3).

Therefore, the circle plotting process of the upper circle FCa (STEPS S4 and SA) is not performed.

Further, in the circle plotting process of the lower circle FCb which is performed thereafter, similarly in the second embodiment, the coordinates of an intersection 2 (or 3) which is an intersection P (having X and Y coordinates (0, −3.2)) of the circumference of the circle having the radius R (=2) with the line extending in the direction of θ (=0 degrees) from the X and Y coordinates (0, −1.2) of the intersection 1 which is the center of the circle are determined (STEPS A4 to A7), and it is determined that the coordinates of the intersection 2 (or 3) are outside the plotting area (between Xmin “−3” and Xmax “3” and between Ymin “−3” and Ymax “3”) (“Yes” in STEP A81).

Then, the X and Y coordinates of the intersection 2 (or 3) which is the intersection P (having X and Y coordinates (0, −3.2)) determined as being outside the plotting area are shifted to X and Y coordinates (here, (0, −3)) closest thereto and positioned in the plotting area (between Xmin “−3” and Xmax “3” and between Ymin “−3” and Ymax “3”) as shown in FIGS. 5B and 5C (STEP A82).

After the coordinates of the intersection 2 (or 3) are shifted to the X and Y coordinates (0, −3) closest thereto and positioned in the plotting area, a color is assigned to the area of a triangle defined by the coordinates of the intersections 1, 2, and 3, and the triangle is plotted (STEP A9).

Subsequently, the other triangles each of which is defined by the coordinates of intersections 1, 2, and 3 wherein the intersection 2 is inside the plotting area Ad are plotted according to the same processing (STEPS A6 to A11) as that of the second embodiment, and as shown in FIGS. 8B and 8C, the lower circle FCb composed of ten triangles arranged in the circumferential direction is displayed on the display output unit 12.

Thereafter, similarly in the circular-cylinder (a figure having circles) plotting process of the embodiment described above, the circular cylinder (a figure having circles) FC (FCb+FCs) having the X and Y coordinates (0, −1.2) of the center, the radius R (=2), and the height (between −2 and 4 in the Z direction) and having no upper circle FCa is plotted in the plotting area Ad (defined by Xmin “−3”, Xmax “3”, Ymin “−3”, Ymax “3”, Zmin “−3”, and Zmin “3”), and is displayed on the display output unit 12 (STEP A7).

Therefore, similarly in the second embodiment, even in the case where the circles FCa and FCb are set to protrude in horizontal directions from the plotting area Ad, it is unnecessary to perform cumbersome and heavy surface processing for precisely fitting the protruding parts in the plotting area Ad. Therefore, it is possible to plot a good-looking circular cylinder (a figure having circles) without using a high-speed high-performance (expensive) processor (CPU).

FIG. 8C shows a display state which is obtained by performing a process of rotating the plotted circular cylinder (a figure having circles) FC shown in FIG. 8B in a planar direction.

Also, even in this third embodiment, similarly in the second embodiment, in the circular cylinder (a figure having circles) plotted as shown in FIGS. 8B and 8C, rectangles of the side surface FCs corresponding to two triangles of the lower circle FCb including a intersection P which is a coordinate point 2 (or 3) shifted into the plotting area Ad have not been plotted for the purpose of convenience; however, they may be plotted.

Therefore, according to the figure plotting device 10 having the above-described configuration, the user sets data on a 3D figure plotting area Ad (Xmin, Xmax, Ymin, Ymax, Zmin, and Zmax) according to the plotting-area setting screen Gv, and inputs plotting data on a circular cylinder (a figure having circles) FC (the radius R, the height in the Z direction, and the X and Y coordinates of the center) according to the 3D graph setting screen Gs. Then, with respect to each of the circles FCa and FCb of both ends of the circular cylinder (a figure having circles) FC, the coordinates of individual intersections of the circumference of the corresponding circle with individual lines extending radially from the coordinates of the center of the corresponding circle at intervals of Δθ are determined on the basis of the data on the plotting area Ad and the plotting data on the circular cylinder (a figure having circles) FC, and a plurality of triangles (grid areas) is formed by connecting the coordinates of the center with the coordinates of each of the intersections and connecting the coordinates of the individual intersections, and the corresponding circle FCa or FCb is plotted by the set of the triangles. Also, with respect to the side surface FCs of the circular cylinder (a figure having circles) FC, quadrangles (grid areas) are formed by lines connecting the coordinates of the individual intersections determined on the circumference of one circle FCa of the circular cylinder (a figure having circles) FC with the coordinates of the individual intersections determined on the circumference of the other circle FCb and a plurality of dividing lines parallel to the circles FCa and FCb, and the side surface FCs is plotted by the set of the quadrangles.

Further, in the case of plotting the circle FCa or FCb as the set of the plurality of triangles (grid areas), if the coordinates of one of two points of a triangle positioned on the circumference of the circle except an apex corresponding to the coordinates of the center of the corresponding circle FCa or is outside of the plotting area Ad set in advance, the coordinates of the corresponding intersection positioned outside the plotting area is shifted to coordinates closest thereto and positioned in the plotting area, and a plurality of triangles (grid areas) is formed by connecting the intersection coordinates including the shifted coordinates, and the circle FCa or FCb is plotted by the set of the formed triangles.

Therefore, even in the case where the plotting data on the circular cylinder (a figure having circles) is set such that the circles FCa and FCb of the circular cylinder protrude from the plotting area Ad, it is unnecessary to perform cumbersome and heavy surface processing for precisely fitting the protruding parts in the plotting area Ad. Therefore, it is possible to plot a good-looking circular cylinder (a figure having circles) FC without using a high-speed high-performance (expensive) processor (CPU).

Also, according to the figure plotting device 10 having the above-described configuration, whether the maximum value Zmax and the minimum value Zmin in the height direction (the Z direction) included in the plotting data of the circular cylinder (a figure having circles) FC are inside the area in the Z direction (between Zmin and Zmax) defined in the data on the plotting area Ad is determined, and if they are inside the plotting area Ad (between Zmin and Zmax), each circle is plotted. In the case where the maximum value Zmax or the minimum value Zmin in the height direction (the Z direction) defined in the plotting data is outside the area in the Z direction (between Zmin and Zmax) defined in the data on the plotting area Ad, the circle positioned outside the area is not plotted.

Therefore, even in the case where one circle of the circular cylinder (a figure having circles) FC is outside the plotting area Ad, it is unnecessary to perform cumbersome and heavy surface processing, and it is possible to plot a good-looking circular cylinder (a figure having circles) FC without one circle in the plotting area Ad.

Also, in every embodiment described above, the case of plotting a circular cylinder (a 3D figure) as a figure having circles has been described; however, examples of a figure having circles may include elliptic cylinders having ellipses at both ends, cones, elliptic cones, spheres, and elliptic spheres. Further, with respect to these figures having circles, in the case where a coordinate point positioned on the circumference of a circle (an ellipse) is outside a plotting area set in advance, the coordinate point positioned outside the plotting area may be shifted to a coordinate point closest thereto and positioned in the plotting area, and the corresponding circle may be plotted.

Also, the upper surface and the lower surface may not be circular, and may have any other shape which can be formed by connecting a plurality of points. Examples of such a shape include circles and polygons, i.e. shapes which can be formed by connecting points with straight lines or curved lines. In this case, if the above-mentioned circle is replaced with a surface having a shape as described above, and the center point of the circle is replaced with the centroid point of the corresponding shape, this technology can be used.

Also, this technology is not limited to the case of plotting the upper surface and lower surfaces of circular cylinders, and can also be used in the case of plotting side surfaces of circular cylinders and in the case of plotting figures other than circular cylinders. In other words, a plane which is a plotting object included in the figure is divided into two or more predetermined shapes (wherein each predetermined shape is a polygon) each of which can be formed by connecting a plurally of points, such that grids are formed, and a shape which can be formed by connecting the plurality of points (in the case of the polygon, a plurality of apexes (The same is true in the following parentheses)) and the centroid point of the predetermined shape is plotted, whereby the predetermined shape (the polygon) is plotted in a plotting area of a display screen of the display unit. On the occasion of plotting the predetermined shape, if at least one of the plurality of points (the plurality of apexes of the polygon) and the centroid point of the predetermined shape is outside the plotting area, another shape different from the predetermined shape (another polygon having a shape different from the shape of the above-mentioned polygon) may be plotted, wherein the another shape can be formed by shifting each point positioned outside the plotting area to a point in the plotting area and connecting the at least one shifted point of the plurality of apexes of the polygon and one or more points, having not been shifted, of the plurality of points of the predetermined shape (the plurality of apexes of the polygon).

Also, all of the methods of the individual processes which are performed by the figure plotting device 10 described in each embodiment that is, all of the methods of various processes such as the circular-cylinder (a figure having circles) plotting process shown by the flow chart of FIG. 3 and the circle plotting processes included in the circular-cylinder (a figure having circles) plotting process and shown by the flow chart of FIG. 4 can be configured as programs executable in a computer, and the programs can be stored in media of external recording devices, such as memory cards (such as ROM cards and RAM cards), magnetic disks (such as floppy (registered as a trade mark) disks and hard disks), optical disks (such as CD-ROMs and DVDs), and semiconductor memories, to distributed. Also, a computer (a CPU) of an electronic device having a display function can read the programs recorded on a medium of an external recording device, and can control operations according to the read programs, thereby implementing the function of plotting figures having circles described in each embodiment, and performing the same processes according to the above-described methods.

Also, data on the programs for realizing the methods may be transmitted in a program code form on a communication network (N), and the program data may be downloaded from a computer device (a program server) connected to the communication network (N), into a storage device of an electronic device having a display function, such that it is possible to realize the above-described function of plotting figures having circles.

The present invention is not limited to the embodiments, and may have various modifications within the scope without departing from the spirit thereof at the time of carrying out the invention. In addition, the embodiments include inventions of various stages, and thus various inventions may be extracted by appropriate combinations of a plurality of disclosed constituent elements. For example, even if some constituent elements are deleted from all the constituent elements shown in the embodiments, or some constituent elements are combined in different forms, a configuration in which the constituent elements are deleted or combined may be extracted as an invention in a case of being capable of solving the problems described in the Problem that the Invention is to Solve and achieving the effects described in the Advantage of the Invention.

What is claimed is:

1. A figure plotting device having a controller, wherein
the controller performs following processes:
plotting a first shape which is formed by connecting a plurality of points included in a plane which is a desired plotting object, thereby plotting the plane in a plotting area of a display screen of a display unit; and
upon plotting the plane, in a case where at least one of the plurality of points of the first shape is outside the plotting area and one or more points of the plurality of points of the first shape is inside the plotting area, plotting a second shape different from the first shape by connecting at least one point and the one or more points, the at least one point being obtained by shifting at least one of the plurality of points of the first shape outside the plotting area to corresponding at least one point positioned inside the plotting area, the one or more points.

2. The figure plotting device according to claim 1, wherein the controller performs following processes:
upon plotting the plane, shifting each of the at least one point positioned outside the plotting area to a position positioned inside the plotting area which is closest to each of the at least one point.

3. The figure plotting device according to claim 1, wherein the controller performs following processes:
on a basis of figure data for plotting a figure including the plane which is the desired plotting object, setting points of a surface of the figure and a centroid of the plane which is the desired plotting object as the plurality of points of the first shape, and plotting the plane.

4. The figure plotting device according to claim 3, wherein the controller performs following processes:
on the basis of the figure data, setting a plurality of points corresponding to a circumference of a circle as the plane which is the desired plotting object, setting a center point of the circle as the centroid of the plane, and plotting the plane, and
in a case where at least one point of two neighboring points of the plurality of points corresponding to the circumference of the circle is outside the plotting area, setting a triangle which includes, as apexes thereof, at least one point and the center point of the circle as the second shape, and plotting the plane, the at least one point being determined by shifting each of the at least one point positioned outside the plotting area to a point positioned inside the plotting area.

5. The figure plotting device according to claim 3, wherein the controller performs following processes:
on a basis of a figure data specifying a circular cylinder as the figure, setting a plurality of points on a circumference of one circle of the circular cylinder and a centroid of the one circle of the circular cylinder as the plurality of the first shape, and plotting the plane.

6. The figure plotting device according to claim 3, wherein the controller performs following processes:
upon plotting the plane, on a basis of a figure data specifying a circular cylinder as the figure, plotting a plurality of rectangles in place of a side surface of the circular cylinder, in which each of the rectangles has, as apexes thereof, a plurality of points positioned on circumferences of two circles of the circular cylinder,
upon plotting one rectangle of the plurality of rectangles,
in a case where at least one of the apexes of the one rectangle is outside the plotting area, not plotting the one rectangle, and
in a case where all of the apexes of the one rectangle are inside the plotting area, plotting the one rectangle.

7. The figure plotting device according to claim 1, further comprising the display unit.

8. A control method of a figure plotting device having a controller comprising following processes:
plotting a first shape which is formed by connecting a plurality of points included in a plane which is a desired plotting object, thereby plotting the plane in a plotting area of a display screen of a display unit; and
upon plotting the plane, in a case where at least one of the plurality of points of the first shape is outside the plotting area and one or more points of the plurality of points of the first shape is inside the plotting area, plotting a second shape different from the first shape by connecting at least one point and the one or more points, the at least one point being obtained by shifting at least one of the plurality of points of the first shape outside the plotting area to corresponding at least one point positioned inside the plotting area, the one or more points.

9. The control method according to claim 8 comprising following processes:
upon plotting the plane, shifting each of the at least one point positioned outside the plotting area to a position positioned inside the plotting area which is closest to each of the at least one point.

10. The control method according to claim 8 comprising following processes:
on a basis of figure data for plotting a figure including the plane which is the desired plotting object, setting points of a surface of the figure and a centroid of the plane which is the desired plotting object as the plurality of points of the first shape, and plotting the plane.

11. The control method according to claim 10 comprising following processes:
on the basis of the figure data, setting a plurality of points corresponding to a circumference of a circle as the plane which is the desired plotting object, setting a center point of the circle as the centroid of the plane, and plotting the plane, and
in a case where at least one point of two neighboring points of the plurality of points corresponding to the circumference of the circle is outside the plotting area, setting a triangle which includes, as apexes thereof, at least one point and the center point of the circle as the second shape, and plotting the plane, the at least one point being determined by shifting each of the at least one point positioned outside the plotting area to a point positioned inside the plotting area.

12. The control method according to claim 10 comprising following processes:
on a basis of a figure data specifying a circular cylinder as the figure, setting a plurality of points on a circumference of one circle of the circular cylinder and a centroid of the one circle of the circular cylinder as the plurality of the first shape, and plotting the plane.

13. The control method according to claim 10 comprising following processes:
upon plotting the plane, on a basis of a figure data specifying a circular cylinder as the figure, plotting a plurality of rectangles in place of a side surface of the circular cylinder, in which each of the rectangles has, as apexes thereof, a plurality of points positioned on circumferences of two circles of the circular cylinder,
upon plotting one rectangle of the plurality of rectangles,
in a case where at least one of the apexes of the one rectangle is outside the plotting area, not plotting the one rectangle, and
in a case where all of the apexes of the one rectangle are inside the plotting area, plotting the one rectangle.

14. A non-transitory recording medium having a program recorded thereon that is executable to control a computer to perform following processes:
plotting a first shape which is formed by connecting a plurality of points included in a plane which is a desired plotting object, thereby plotting the plane in a plotting area of a display screen of a display unit; and
upon plotting the plane, in a case where at least one of the plurality of points of the first shape is outside the plotting area and one or more points of the plurality of points of the first shape is inside the plotting area, plotting a second shape different from the first shape by connecting at least one point and the one or more points, the at least one point being obtained by shifting at least one of the plurality of points of the first shape outside the plotting area to corresponding at least one point positioned inside the plotting area, the one or more points.

15. The non-transitory recording medium according to claim 14, wherein the program is executable to control the computer to perform following processes:
upon plotting the plane, shifting each of the at least one point positioned outside the plotting area to a position positioned inside the plotting area which is closest to each of the at least one point.

16. The figure plotting device according to claim 14, wherein the program is executable to control the computer to perform following processes:
on a basis of figure data for plotting a figure including the plane which is the desired plotting object, setting points of a surface of the figure and a centroid of the plane which is the desired plotting object as the plurality of points of the first shape, and plotting the plane.

17. The figure plotting device according to claim 16, wherein the program is executable to control the computer to perform following processes:
on the basis of the figure data, setting a plurality of points corresponding to a circumference of a circle as the plane which is the desired plotting object, setting a center point of the circle as the centroid of the plane, and plotting the plane, and
in a case where at least one point of two neighboring points of the plurality of points corresponding to the circumference of the circle is outside the plotting area, setting a triangle which includes, as apexes thereof, at least one point and the center point of the circle as the second shape, and plotting the plane, the at least one point being determined by shifting each of the at least one point positioned outside the plotting area to a point positioned inside the plotting area.

18. The figure plotting device according to claim 16, wherein the program is executable to control the computer to perform following processes:
on a basis of a figure data specifying a circular cylinder as the figure, setting a plurality of points on a circumference of one circle of the circular cylinder and a centroid of the one circle of the circular cylinder as the plurality of the first shape, and plotting the plane.

19. The figure plotting device according to claim 16, wherein the program is executable to control the computer to perform following processes:
upon plotting the plane, on a basis of a figure data specifying a circular cylinder as the figure, plotting a plurality of rectangles in place of a side surface of the circular cylinder, in which each of the rectangles has, as apexes thereof, a plurality of points positioned on circumferences of two circles of the circular cylinder,
upon plotting one rectangle of the plurality of rectangles,
in a case where at least one of the apexes of the one rectangle is outside the plotting area, not plotting the one rectangle, and
in a case where all of the apexes of the one rectangle are inside the plotting area, plotting the one rectangle.
